(19) United States
(12) Patent Application Publication
(10) Pub. No.: US 2002/0171074 A1
(43) Pub. Date: Nov. 21, 2002

(54) Integrated column structural body

(76) Inventor: Sumiko Imai, Tokyo (JP)

Correspondence Address: KODA & ANDROLIA, Suite 3850, 2029 Century Park East, Los Angeles, CA, 90067-3024, US

(21) Appl. No.: 10/150,248

(22) Filed: May 17, 2002

(30) Foreign Application Priority Data
May 21, 2001 (JP) 2001-188847

(51) Int. Cl. A01K 3/00

(52) U.S. Cl. 256/13.1

(57) ABSTRACT

An integrated column structural body including a rail-shaped core body, piping disposed around the core body so as to be inside recessed portions of the rail-shaped core body, and a joint element for holding the core body and piping together. Installation members are provided on the top of the column structural body so that advertising signs, roof structures, etc. are installed on the column structural body. Also, horizontal guardrails can be horizontally disposed on the column structural body.

### BACKGROUND OF THE INVENTION

1. Field of the Invention

The present invention relates to a structural body on which various objects that are installed on the sides of streets, etc. can be attached in an integrated fashion.

2. Prior Art

Sidewalks are built on the sides of streets; however, with the progressive development of a vehicular society, the presence and significance of sidewalks have faded.

Generally, guide rails are installed on the sides of sidewalks in order to provide protection of pedestrians from vehicles.

In sidewalks, many different structured objects are installed including illumination light sources, telephone boxes, bus stops, advertising media, etc. in addition to power poles, signal light poles and various information means such as telephone wires; and they are generally installed without any unified concept.

Thus, though many different objects are installed along sidewalks including illumination light sources, telephone boxes, bus stops, advertising media, power poles, signal light poles, various information means such as telephone wires, they are installed in disorder, not basing upon any unifying principle. Thus, there are also problems in terms of function of such objects, thus deteriorating the esthetic appearance of the streets and towns.

Furthermore, guide rails vary streets to streets, and rod-form bodies of street fences on which such guide rails are installed and bars of safety fences for automobiles are not constructed according to a particular concept.

In other words, various non-unified shapes and structures are employed, causing the interchangeability of such objects to be hindered. Such shapes and structures also differ in terms of function, thus lacking unity. Accordingly, such structures do not contribute to the scenic appearance of streets and towns and are a source of disharmony.

### SUMMARY OF THE INVENTION

Accordingly, the object of the present invention is to provide an integrated column structural body that offers a uniformed function that is desirable in terms of both function and esthetic appearance on the streets.

The above object is accomplished by a unique structure for an integrated column structural body that comprises a core body, piping disposed around this core body, and joint elements that hold such core body and piping groups together. This integrated column structural body functions as a mounting device so that various objects that are installed on the side of streets, such as bus stops, telephone boxes, benches, advertising displays and roofs are provided thereon, thus being usable in various applications.

The core body in this integrated column structural body is a polygonal-radiate form body, so that piping and electrical wires can be installed around the core body in an orderly fashion.

The core body may take a rail form shape, so that utilization is facilitated. Since the cross-section of such a core body is a rail-form shape, the core body has a high strength and rigidity; and piping can be easily installed around the core body by way of such piping being set in the recessed portions of the core body.

The integrated column structural body of the present invention can be used as a supporting column for guardrails; and in this case, the column structural body is comprised of a core body, piping installed around the circumference of the core body, and joint elements disposed on the core body so as to hold the core body and piping together, and installation holes are formed horizontally in the core body so that guardrails are mounted on the column structural body by way of installing the guardrails in such installation holes.

Furthermore, in the present invention, the column structural body is comprised so that it includes a core body, piping disposed around this core body, and joint elements provided on the core body so as to hold the core body and piping together, and the joint elements are provided with attachment structures so that various external objects can be attached using such attachment structures.

Further in the present invention, the column structural body may be comprised of a core body, piping disposed around this core body, joint elements provided on the core body so as to hold the core body and piping together, and a mounting plate disposed on the core body, so that mounting elements for mounting, for instance, a roof and illumination devices can be installed thereby.

### BRIEF DESCRIPTION OF THE DRAWINGS

FIG. 1 shows one embodiment of the integrated column structural body according to the present invention;

FIG. 2 shows, in cross section, the integrated column structural body shown in FIG. 1;

FIG. 3 shows the integrated column structural body according to one embodiment of the present invention used for attaching a display element;

FIG. 4A is a top view of one of the joint elements of the integrated column structural body according to one embodiment of the present invention, FIG. 4B being a cross section taken along the lines 4B-4B in FIG. 4A;

FIG. 5A shows the integrated column structural body according to another embodiment of the present invention with a roof member attachment element mounted to the top part thereof, FIG. 5B being a cross section taken along the lines 5B-5B in FIG. 5A;

FIG. 6 shows the integrated column structural body according to one embodiment of the present invention used for attaching a display element for advertising, etc;

FIG. 7 shows the integrated column structural bodies according to one embodiment of the present invention used for installing a telephone box;

FIGS. 8A, 8B and 8C are diagrams in which the integrated column structural body according to one embodiment of the present invention is used for installing the roof of a bus stop; and

FIG. 9 is the integrated column structural body according to one embodiment of the present invention used for installing a bus stop.

### DETAILED DESCRIPTION OF THE INVENTION

Embodiments of the present invention will be described below with reference to the accompanying drawings.

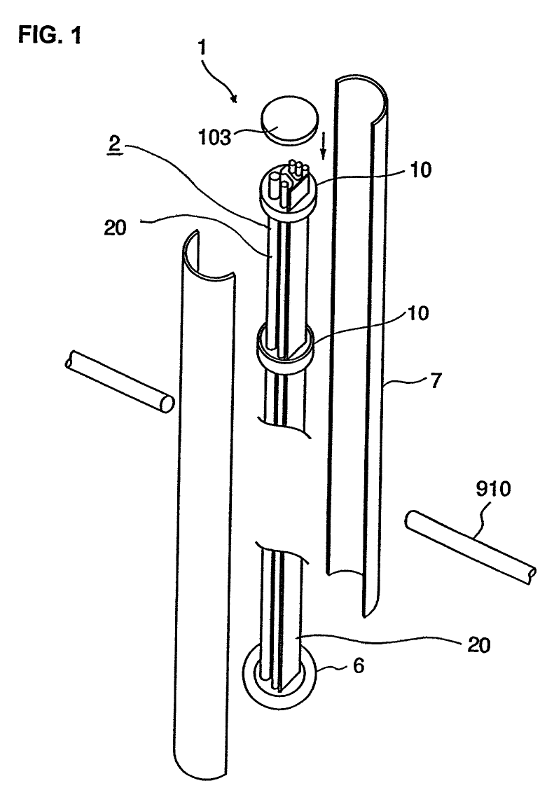

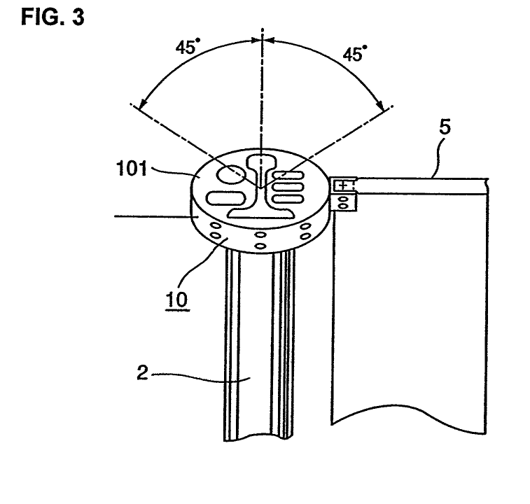

FIG. 1 is a perspective view of an integrated column structural body 1 according to one embodiment of the present invention. In this integrated column structural body 1, rail-shaped bodies 20 are employed as a core body 2 so that the core body 2 functions as the core of the column structural body 1. Joint elements 10 are provided on the rail-shaped bodies 20; and holes 3 are, as seen from FIG. 3A, formed in a top plate 11 of each of the joint elements 10 so that, in addition to the rail-shaped bodies 20, piping for informational use, power supplies, the passage of water piping, etc. are installed so that they are passed through the holes 3.

The rail-shaped body 20 may be that of a commonly used rail itself and those having a cross-sectional shape of commonly used rail. Since the commonly used rails are used, utilization is easy. The commonly used rails and those having the commonly used rail cross-sectional shape are rigid with a high strength, and as a result, the installation of piping around the core body 2 is facilitated because of the presence of recessed portions.

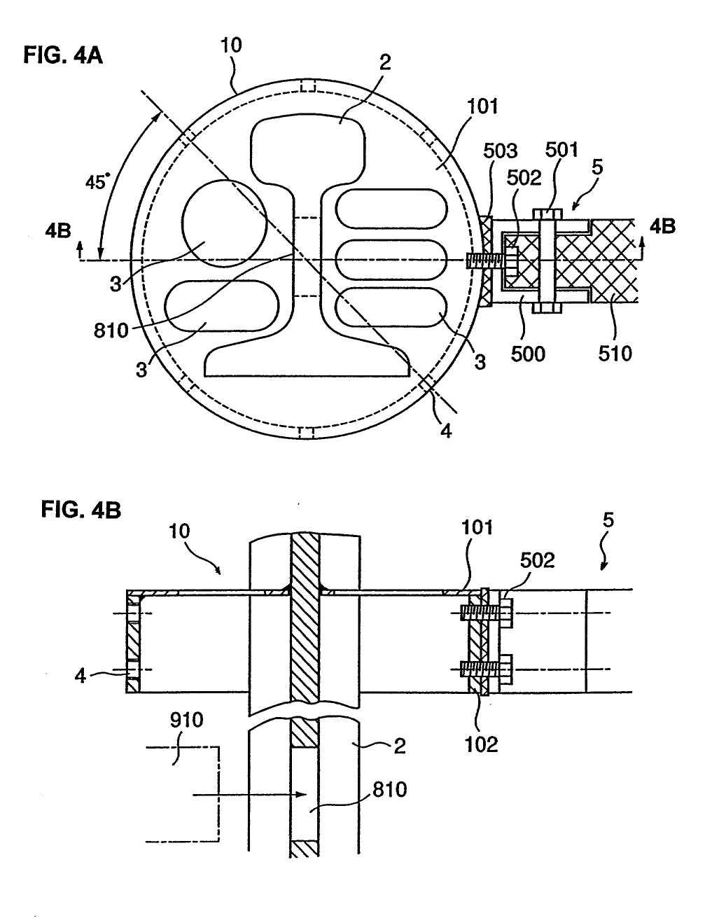

As seen from FIG. 4A, a plurality of holes 3 of different shapes and sizes are opened in the top plate 101 so that the piping 3 are positioned on both sides of the rail-shaped body 20 by being installed in such holes 3.

Furthermore, in addition to forming the core portion of the integrated column structural body 1 by the core body 2 of a rail shape, it is also possible to use materials having a cruciform cross section (90 degrees) or a Y-shaped cross section (120 degrees) in view of the fact that such bodies have strength and recessed portions. In addition, polygonal-radiate form members (divided at angles of 45 degrees or 30 degrees, etc.) may also be used.

As seen from FIG. 4, electrical wires and piping such as water pipes are compactly installed around the recessed portions of the rail-shaped body 20.

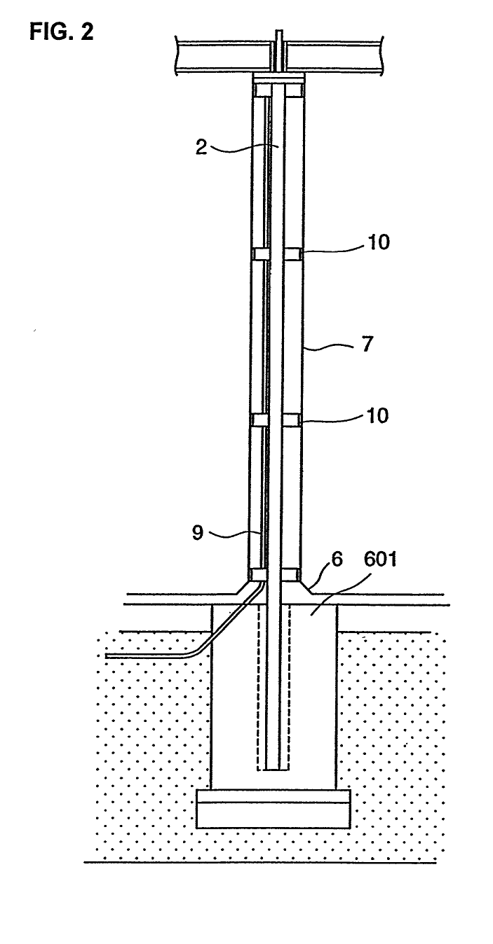

Joint elements 10, which are fixed to the rail-shaped body 20 and having holes 3 that allow the passage of electrical wires and water piping 9, etc. are provided on the rail-shaped body 20. The number of the joint elements is determined in accordance with the length of the rail-shaped body 20 and the length of the electrical wires and water piping 9 (see FIG. 2), etc. The rail-shaped body 20, the electrical wires and water piping 9, etc. are fastened and held together by means of these joint elements 10.

A plurality of the joint elements 10 are installed in accordance with the length and use of the integrated column structural body 1. Since the length of the integrated column structural body 1 varies according to its application and conditions of use, it is convenient to prepare several types of column structural bodies 1 so that they are ready to be used for particular purposes.

For example, in cases where the integrated column structural body 1 is used as a supporting column for the roof of a bus stop, a relatively long integrated column structural body 1 is used. In cases where the integrated column structural body 1 is used as a guardrail column or a supporting column for attaching seats for a bus stop and benches, short column structural bodies 1 are used.

For convenience of different structures and purposes, it is preferable that the rail-shaped body 20 be set at a unit length; and in cases where a longer length is required, a plurality of rail-shaped bodies 20 are connected by connecting couplings.

In addition, since the integrated column structural body 1 is made into a single unit by means of the joint elements 10, the integrated column structural body 1 can be assembled and then transported “as is.”

Since the rail-shaped body 20 is an existing item, it can be easily obtained and conveniently used. The shape and structure of this rail-shaped body 20 provides a sufficient strength, and the shape is also suitable for the alignment of holes. Furthermore, a circular structure can be used for the elements that envelop the rail-shaped body 20, thus the rail-shaped body 20 is significantly desirable as a column.

Of course, besides the circular shape as shown in FIG. 4A, the cross-section of the joint elements 10, when viewed axially, can be an elliptical shape, square shape or other angular shape.

The detail of the structure of the joint elements 10 is shown in FIG. 4B. Each joint element 10 is comprised of a top plate 101 and a cylindrical member 102. The cylindrical member 102 surrounds the circumference of the edge portion of the top plate 101 and is attached to the top plate 101.

As seen from FIG. 3, a display element 5 for advertising messages, etc. can be attached to the cylindrical member 102 of the integrated column structural body 1 by means of screws. In other words, as seen from FIG. 4A, the display element 5 is attached by a bolt 501 to the cylindrical member 102 by way of screwing the end portion of a display panel 510 to a C-shaped attachment bracket 500 that is secured to the cylindrical member 102 with bolts 502.

This C-shaped attachment bracket 500 is fastened in a detachable manner in screw holes 4 formed in the cylindrical member 102 by means of the bolts 502 with a packing 503 interposed in between. Such screw holes 4 are formed in the circumference of the cylindrical member 102 at a plurality of locations.

In addition, various other members that are located on the sides of streets can of course be attached to the attachment bracket 500.

Besides advertising messages, bus destination signs, etc. can be displayed on the display element 5 in cases where the integrated column structural body 1 is used as a part of a bus stop.

Thus, items that were formerly installed in a different manner on the side of streets can be installed in an integrated or uniform manner on the integrated column structural body 1 of the present invention.

As seen from FIGS. 1 and 2, covers 7 are provided on the integrated column structural body 1. More specifically, covers 7 are attached to the cylindrical members 102 of the joint elements 10 by means of screws, bolts mounted in the screw holes 4 of the cylindrical members 102.

Furthermore, in addition to advertising messages, decorative designs can be provided on the covers 7, thus making the column structural bodies a preferable object from the standpoint of the scenic appearance of the street. Distinguishing features of the streets can be emphasized by changing the design (or color) of the covers 7 from block to block in town.

Furthermore, the covers 7 can be transparent. Also, by way of installing decorative electrical illumination inside the covers 7, the atmospheric feeling of the streets can be changed season to season.

As shown in FIG. 2, the integrated column structural body 1 is secured at the leg section thereof in the ground by an appropriate means using a fastening base 6. The integrated column structural body 1 can be secured by, for instance, by concrete 601. Various other securing means and methods can be employed in the present invention to secure the integrated column structural body 1 upright.

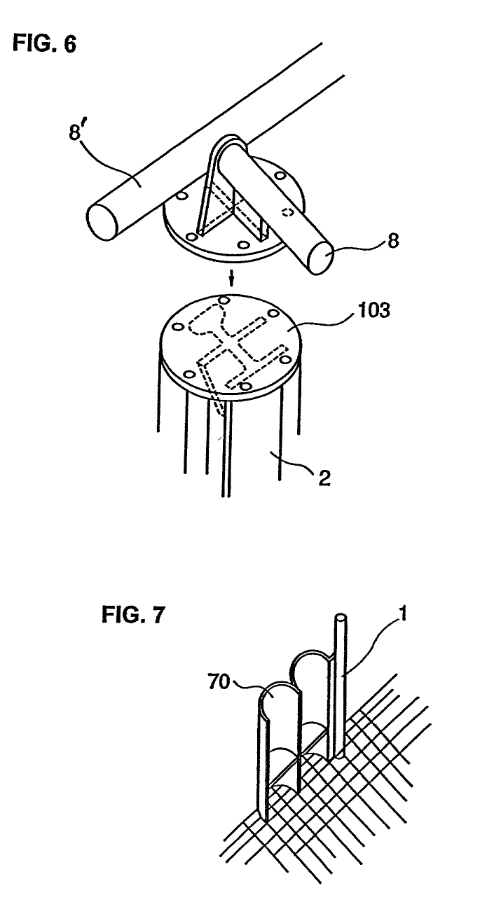

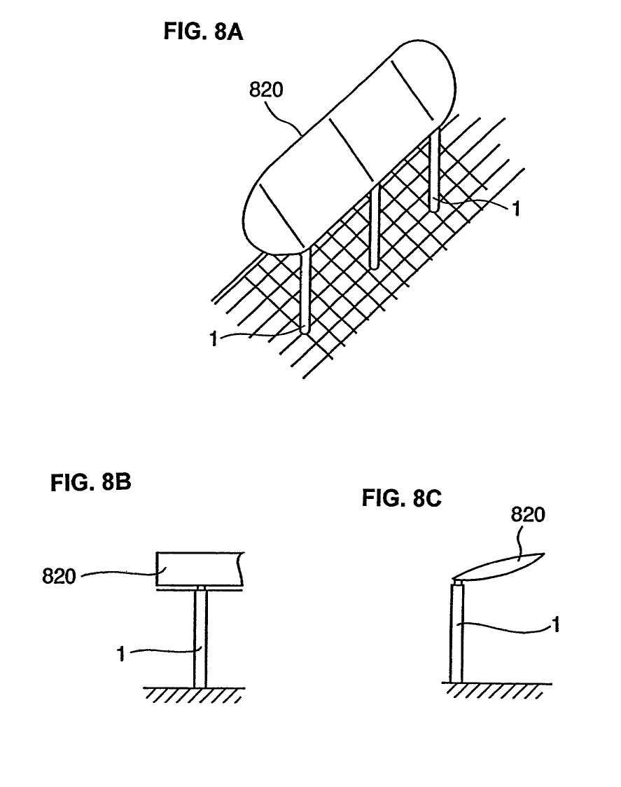

Furthermore, the integrated column structural body 1 can be used to mount roofs of bus stops, etc. on the integrated column structural body 1. In other words, as shown in FIG. 6, roof structural members 8 are provided on the top surfaces of a plurality of integrated column structural bodies 1 (FIG. 6 showing one column structural body 1), and as seen from FIGS. 8A, 8B and 8C, a roof 820 is installed on the integrated column structural bodies 1 using the roof structural members 8.

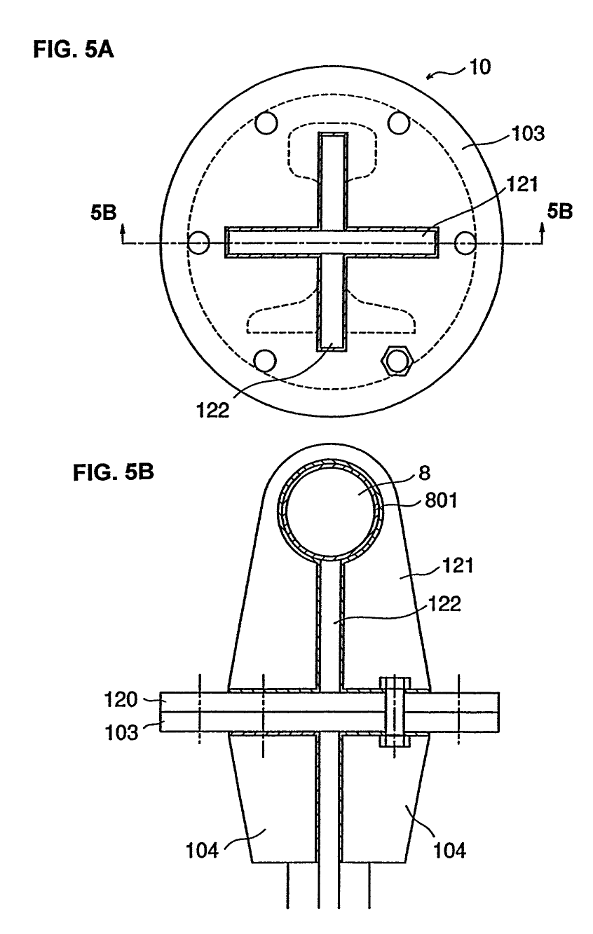

For this purpose, as shown in FIGS. 5A and 5B and FIG. 6, the top plate 103 of the joint element 10 is provided on the top surface of each one of the integrated column structural bodies 1. The top plate 103 is constructed in a “blind” configuration that means that the top plate 103 has no holes for receiving the rail-shaped bodies 20, piping, etc., and a mounting plate 120 is attached to the upper surface of the blind top plates 103 by means of, for instance, bolts. To this mounting plate 120, supporting members 121 that have supporting holes 801 are fastened by welding, etc., so that roof structural members 8 (pipe members in this case) are passed through the supporting holes 801 and thus held in the supporting members 121.

In this case, as shown in FIG. 5A, the direction of length of the supporting member 121 is set at right angles to the direction of length of the rail-shaped body 20. Since the directions coincide, the structure shown in FIG. 5A is desirable in terms of strength. Furthermore, it is even more desirable if the directions also coincide with the directions of reinforcing members 122 which will be described below.

For purposes of reinforcement, a reinforcing member 122 is provided for the supporting member 121 as shown in FIGS. 5A and 5B. This reinforcing member 122 is fastened to the mounting plate 120 and supporting member 121 by welding, etc. In this shown example, the direction of length of the reinforcing member 122 coincides with the direction of length of the rail-shaped body 20.

Reinforcing members 104 can be attached to the blind top plate 103 of the top joint element 10 of each integrated column structural body 1 so that the reinforcing members 104 are positioned below the blind top plate 103. As seen from FIG. 5B, the directions of length of these reinforcing members 104 are oriented at right angles to the rail-shaped body 20. With an employment of the supporting members 121, the reinforcing members 122 and reinforcing members 104 arranged in the directions shown in FIG. 5B, a much greater effect in terms of strength is obtained.

As shown in FIG. 6, the roof structural member 8 is passed through the installation hole 801 of the supporting member 121 and is fastened by welding, etc. thereto. Furthermore, another structural member 8′ is connected to the structural member 8, and an assembly that forms a roof of the type shown in FIGS. 8A, 8B and 8C is constructed.

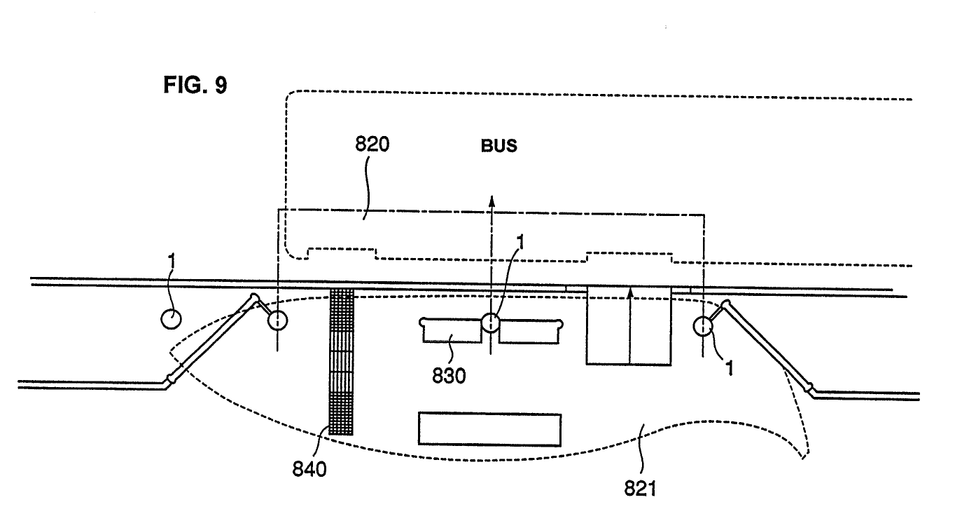

FIG. 9 shows a bus stop seen from above. Here, roofs 820 and 821 are installed on the integrated column structural bodies 1, and benches 830 are also installed using the integrated column structural bodies 1.

More specifically, the installation of the benches 830 is accomplished in the following manner: screw holes 4 are formed in the cylindrical member 102 that is provided around the circumferential edge of the top plate 101 of the joint element 10 as in FIG. 4B, and attachment brackets are secured to the benches 830; then the brackets of the bench 830 are fastened to the joint element 10 by bolts passing through the screw holes 4 of the cylindrical member 102, thus attaching the benches 830 to the integrated column structural bodies 1.

A guidance display 840 for blind persons can be also provided on the integrated column structural bodies 1.

The integrated column structural body 1 can also be used as a column for guardrails that protect pedestrians from vehicles.

Various joining method and structures can be utilized for building guardrails. One example is shown in FIGS. 4A and 4B and FIG. 1. In this example, the rail-shaped body 20 is provided with horizontal installation holes 810 (installation holes are formed also in the covers 7), and pipe-form tube body 910 is horizontally passed through the installation holes 810 of the rail-shaped body 20 (and installation holes of covers 7).

Since the rail-shaped body 20 possesses strength (rigidity), installation of the pipe-form tube body 910 can be made easy.

As another structure for installing the pipe-form tube body 910, a structure can be employed in which the cylindrical member 102 surrounding the circumferential edge portion of the top plate 101 of each joint element 10 is formed with holes, and pipe-form tube bodies 910 is inserted in the holes. As seen from FIGS. 4A and 4B, a plate-form guardrail element can be employed in place of the display element 5 for providing guardrail that uses the integrated column structural bodies 1.

Furthermore, in order to connect the pipe-form tube body 910 to the cylindrical member 102, it is also possible to form, instead of the screw holes 4, installation holes for the pipe body 910 in the cylindrical member 102.

Various other joining methods and structures can be of course employable in the present invention.

An illumination light source can be installed on the top surface of the integrated column structural body 1, thus using the integrated column structural body 1 for nighttime illumination in the form of an outdoor lamp, etc. This can be done by passing electrical wires through the holes 3 opened in the top plate 101 and by installing an illumination light source on the top or on the side surface of the covers 7 of the integrated column structural body 1.

The base of each one of light-source electrical lamps can be attached to the screw hole 4 of the cylindrical member 102, so that the electrical lamps surround the circumferential edge of the top plate 101.

Furthermore, a telephone box can also be installed using the integrated column structural body 1 of the present invention.

In FIG. 7, the covering body 70 of a U-shaped telephone box is attached to the integrated column structural body 1. Telephones are set on the horizontal plate provided inside the U-shaped covering body 70.

More specifically, the screw holes 4 of the cylindrical member 102 of a joint element 10 is utilized, and the covering body 70 are fastened and attached to the cylindrical member 102 using screws (see FIGS. 4A and 4B).

Of course, the covering body 70 can also be fastened in place on the integrated column structural body 1 by slits, cutouts, etc. formed in the covers 7 of the integrated column structural body 1.

As seen from the above, according to the present invention, various objects such as illumination light sources, telephone boxes, bus stops and advertising media are provided on and/or inside the integrated column structural body(s). Since the integrated column structural body(s) is superior in terms of both function and esthetic appearance, conventional problems are solved and streets look neatly with uniformity in an orderly fashion.

Furthermore, guide rails designed on the basis of a single concept can be installed along the streets using the unified integrated column structural bodies of the present invention.

1. An integrated column structural body comprising:
a core body,
piping disposed around said core body, and
a joint element for holding said core body and piping together.

2. The integrated column structural body according to claim 1, wherein said core body is a polygonal-radiate form body.

3. The integrated column structural body according to claim 1 or 2, wherein said core body is a rail-shaped body.

4. An integrated column structural body comprising:
a core body,
piping disposed around said core body, and
a joint element for holding said core body and piping together, wherein
said core body is provided with an installation hole for mounting a guardrail therethrough.

5. An integrated column structural body comprising:
a core body,
piping disposed around said core body, and
a joint element for holding said core body and piping together, wherein
said joint elements is provided with an attachment structure for attaching various objects thereto.

6. An integrated column structural body comprising:
a core body,
piping disposed around said core body, and
a joint element for holding said core body and piping together, wherein
said core body is provided with a mounting plate disposed on a top end of said core body, so that attachment members for attaching roof members and illumination devices are installed.
